(19) United States
(12) Patent Application Publication
(10) Pub. No.: US 2004/0248627 A1
(43) Pub. Date: Dec. 9, 2004

(54) Method for applying film onto electric part

(76) Inventor: Chun Fu Kuo, Taichung (TW)

Correspondence Address: Chun Fu Kuo, P.O. Box 63-99, Taichung, 406, TW

(21) Appl. No.: 10/884,470

(22) Filed: Jul. 3, 2004

Related U.S. Application Data
(63) Continuation-in-part of application No. 09/923,856, filed on Aug. 7, 2001.

(51) Int. Cl. H04H 1/00; H04B 1/06

(52) U.S. Cl. 455/575.1; 455/354; 455/899

(57) ABSTRACT

A method for making an electric part includes preparing and disposing a prototype of the electric part in a mold device, vacuuming two materials, poly-ol and crosslinking agent, in two containers and in a temperature lower than 80° C., and then feeding the two materials into a receptacle, for being stirred within within the receptacle, and to form a mixed material, poly-urethane. The mixed material is then injected into the mold device, to have the mixed material engaged onto the prototype of the electric part, and to form a shock absorbing film on the prototype of the electric part, and to protect the electric part.

The present invention is a continuation-in-part of U.S. patent application Ser. No. 09/923,856, filed 07 Aug. 2001, pending, but to be abandoned.

### BACKGROUND OF THE INVENTION

1. Field of the Invention

The present invention relates to a method, and more particularly to a method for applying a shock absorbing film onto outer peripheral portions of electric elements or parts.

2. Description of the Prior Art

Typical electric facilities or devices may comprise an outer housing to receive various electric elements or parts disposed therein, to protect the electric elements or parts, and to prevent the electric elements or parts from being damaged by sun shine, rain, or other objects.

For example, U.S. Pat. No. 4,648,130 to Kuznetz discloses one of the typical electric facilities or devices comprising an outer hand band made of woven or non-woven fabric and having a central pouch section to receive and to protect various electric elements or parts therein. However, the outer hand band of woven or non-woven fabric may not be solidly attached onto the electric elements or parts, and may not be used as a shock absorbing film for the electric elements or parts.

U.S. Pat. No. 6,459,890 to Kim discloses another typical electric facility or device comprising an outer body element to receive and to protect various electric elements or parts therein. However, the outer body element has no shock absorbing films applied thereon, such that the outer body element may not be prevented from being damaged by shocks or the like.

U.S. Pat. No. 5,319,522 to Mehta discloses a further typical electric facility or device comprising a circuit board including an encapsulating shell engaged thereon and secured thereon, in which the encapsulating shell is formed by a shrinkable material that will shrink around the printed circuit board. However, the printed circuit board may be damaged while heating the shrinkable material.

U.S. Pat. No. 5,554,821 to Patterson et al. discloses a computer peripheral card having a solid one-piece housing provided or engaged onto a circuit board. However, the solid one-piece housing is normally attached or secured onto the circuit board with molding or mold-injection processes, and should be heated to a great temperature that may damage the circuit board.

U.S. Pat. No. 5,726,391 to Iyer et al., and U.S. Pat. No. 6,084,109 to Chu et al. disclose two typical methods or processes for electronics packaging purposes. However, similarly, the materials for forming the electronics packaging devices should also be heated to a great temperature that may damage the electric elements or parts.

The present invention has arisen to mitigate and/or obviate the afore-described disadvantages of the conventional electric elements or parts packaging devices or outer housings.

### SUMMARY OF THE INVENTION

The primary objective of the present invention is to provide a method for applying a shock absorbing film onto outer peripheral portions of electric elements or parts or housings.

In accordance with one aspect of the invention, there is provided a method for making an electric part, the method comprising preparing and disposing a prototype of the electric part in a mold device, disposing a first material, poly-ol, in a first container, in a temperature lower than 80° C., vacuuming the first container, to remove bubbles from the first material, disposing a second material, crosslinking agent, in a second container, in a temperature lower than 80° C., vacuuming the second container, to remove bubbles from the second material, feeding the first and the second materials into a receptacle, stirring the first and the second materials together within the receptacle, to form a mixed material, poly-urethane, and injecting the mixed material into the mold device, to have the mixed material engaged onto the prototype of the electric part, and to form a shock absorbing film on the prototype of the electric part, in order to form the electric part. It is to be noted that the first material (poly-ol) and the second material (crosslinking agent) may be mixed and stirred together in low temperature, and may also be injected into the mold device without being heated, such that the electric parts will not be damaged by the materials that are maintained in low temperature.

The mold device includes a lower mold, and a first upper mold engaged onto the lower mold, to form a mold cavity therein and to form the prototype of the electric part in the mold cavity defined between the lower mold and the first upper mold of the mold device.

The mold device includes a second upper mold engaged onto the lower mold after the first upper mold has been removed from the lower mold, to form a second mold cavity between the prototype and the second upper mold, the mixed material is injected into the second mold cavity and engaged onto the prototype of the electric part.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a flow chart illustrating processes of a method in accordance with the present invention;

FIG. 2 is a perspective view of an outer housing of a portable phone to be made with a method in accordance with the present invention;

FIG. 3 is a cross sectional view of the outer housing of the portable phone, taken along lines 3-3 of FIG. 2;

FIG. 4 is a partial cross sectional view illustrating a mold device for making or forming a prototype of the outer housing of the portable phone;

FIG. 5 is a partial cross sectional view similar to FIG. 4, illustrating the mold device for applying a shock absorbing film onto the prototype of the outer housing of the portable phone;

FIG. 6 is a partial cross sectional view similar to FIG. 3, illustrating a portion or one half of the outer housing of the portable phone; and

FIGS. 7, 8 are partial cross sectional views similar to FIGS. 4 and 5, illustrating the mold device for forming or making the other portion or the other half of the outer housing of the portable phone.

### DETAILED DESCRIPTION OF THE PREFERRED EMBODIMENT

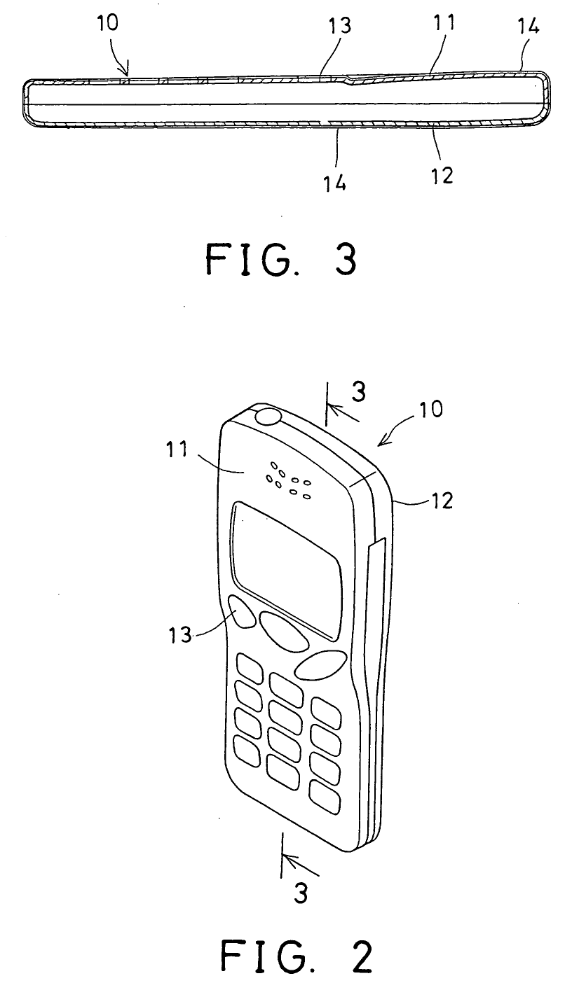

Referring to the drawings, and initially to FIGS. 2 and 3, illustrated is an electric element or part 10, such as an outer housing 10 of a portable phone to be made with a method in accordance with the present invention. For example, the housing 10 comprises one or more portions, such as two halves or two housing members 11, 12 which may be made or manufactured separately and then secured together with fasteners or latches (not shown) or the like. The front housing member 11 may include a number of openings 13 formed therein for receiving buttons (not shown).

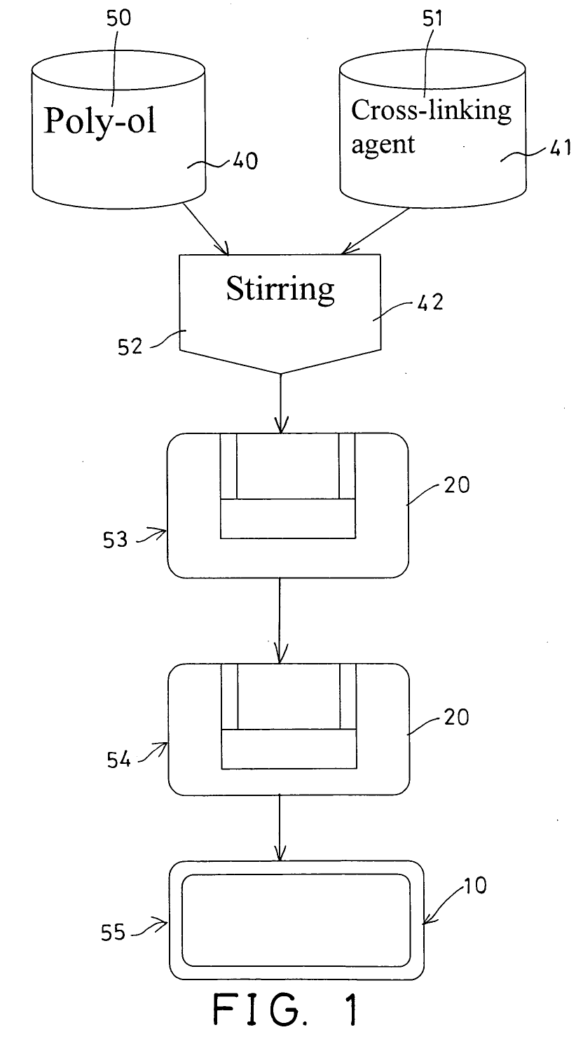

The method in accordance with the present invention is provided to apply a shock absorbing film 14 onto an outer peripheral portion of the electric element or part or housing 10. For example, as shown in FIG. 1, two containers 40, 41 are first provided to receive two different materials, such as poly-ol 50, and crosslinking agent 51 respectively. It is preferably that the two containers 40, 41 are vacuumed to remove bubbles from the sticky materials, i.e., poly-ol 50, and crosslinking agent 51 respectively.

The two materials 50, 51 are then forced or moved or fed into a receptacle 42, within which the two sticky materials 50, 51 are then stirred and mixed together by such as a high speed stirring process with such as a stirring machine (not shown), in order to form a mixed material 52, i.e., poly-urethane. It is to be noted that the two sticky materials 50, 51 may be fed into the receptacle 42 in predetermined speed and/or quantity.

After the stirring process, it is preferable that the receptacle 42 is also vacuumed to remove bubbles from the sticky and mixed material 52, which will then be injected or fed into mold devices 20 that will be described hereinafter. It is to be noted that the two materials 50, 51 may be received in the containers 40, 41 in low temperature, such as below or lower than 80° C., and the mixed material 52 contained in the receptacle 42 is also not heated and will also be received in the receptacle 42 in low temperature, such as below 80° C.

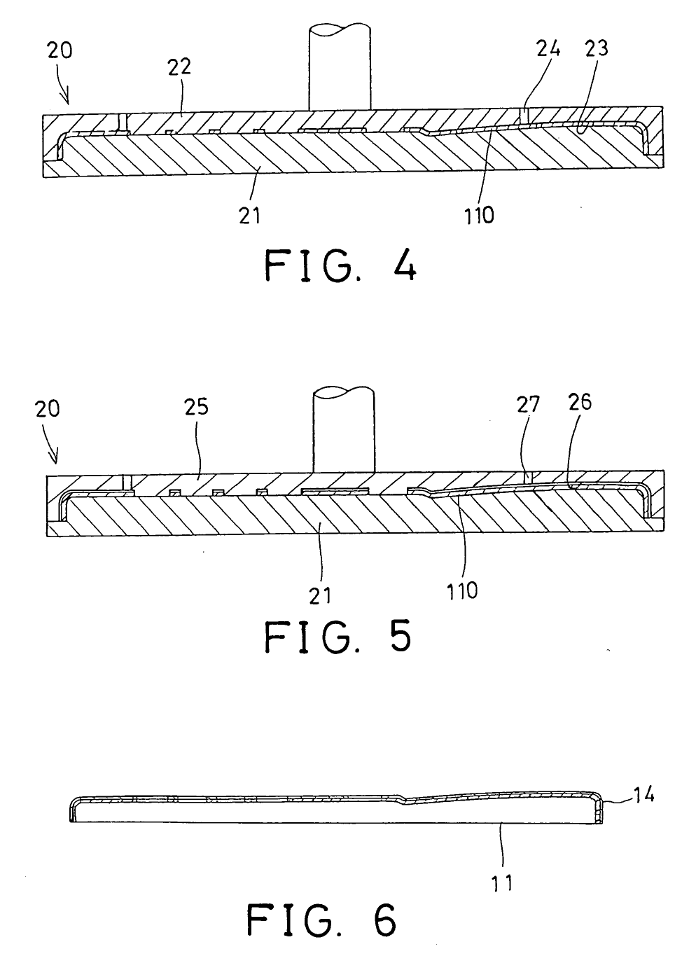

Referring next to FIGS. 4 and 5, illustrated is a mold device 20 for making the housing 10, or for applying the shock absorbing film 14 onto outer peripheral portion of the housing 10, or of the housing members 11, 12 of the housing 10. For example, the mold device 20 includes a lower mold 21 and a first upper mold 22 engaged onto the lower mold 21, to form or define a mold cavity 23 therein (FIG. 4), and to inject materials into the mold cavity 23 via a passage 24 of the upper mold 22, to form a prototype 110 of the housing member 11 or of the housing 10.

The first upper mold 22 is then removed from the lower mold 21, and a second upper mold 25 is then engaged onto the lower mold 21, to form or define a mold cavity 26 between the prototype 110 and the upper mold 25 (FIG. 5), and to inject the mixed material 52 into the mold cavity 26 via a passage 27 of the upper mold 25 in process 53 of FIG. 1, to apply the mixed material 52 onto the prototype 110, in order to form the shock absorbing film 14 onto the housing member 11 or on the housing 10.

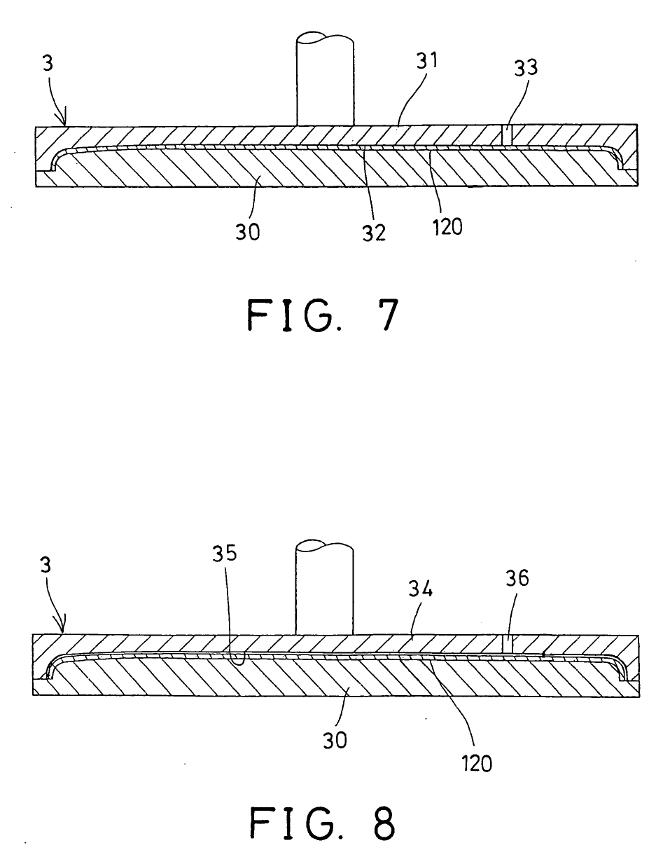

Similarly, as shown in FIG. 7, another mold device 3 may be provided for making the other housing member 12 or the housing 10, and also includes a lower mold 30 and a first upper mold 31 engaged onto the lower mold 30, to form or define a mold cavity 32 therein, and to inject materials into the mold cavity 32 via a passage 33 of the upper mold 31, to form a prototype 120 of the housing member 12 or of the housing 10.

The first upper mold 31 is then removed from the lower mold 30, and a second upper mold 34 is then engaged onto the lower mold 30, to form or define a mold cavity 35 between the prototype 120 and the upper mold 34 (FIG. 8), and to inject the mixed material 52 into the mold cavity 35 via a passage 36 of the upper mold 34, to apply the mixed material 52 onto the prototype 120, in order to form the shock absorbing film 14 onto the housing member 12 or on the housing 10.

The housing members 11, 12 of the housing 10 may thus be made separately and may each include a shock absorbing film 14 formed or applied thereon. The housing members 11, 12 may then be secured together with fasteners or latches (not shown) or the like. Alternatively, the housing members 11, 12 of the housing 10 may first be secured together, and then have the shock absorbing film 14 directly formed or applied thereon with a single mold device 20 or 3.

It is to be noted that the mixed material 52, i.e., poly-urethane may be sticky, but may become cured within the mold device 20 and/or 3 in a timing process 54 in FIG. 1, for example, and may be formed as a non-sticky shock absorbing film 14 for the housing members 11, 12 and/or for the housing 10, and to form as a final produce 10 in process 55 of FIG. 1.

Accordingly, the method in accordance with the present invention may be used for applying a shock absorbing film onto outer peripheral portions of electric elements or parts.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for making an electric part, said method comprising:
preparing and disposing a prototype of the electric part in a mold device,
disposing a first material, poly-ol, in a first container, in a temperature lower than 80° C.,
vacuuming said first container, to remove bubbles from said first material,
disposing a second material, crosslinking agent, in a second container, in a temperature lower than 80° C.,
vacuuming said second container, to remove bubbles from said second material,
feeding said first and said second materials into a receptacle,
stirring said first and said second materials together within said receptacle, to form a mixed material, poly-urethane, and
injecting said mixed material into said mold device, to have said mixed material engaged onto said prototype of the electric part, and to form a shock absorbing film on said prototype of the electric part, in order to form the electric part.

2. The method as claimed in claim 1, wherein said mold device includes a lower mold, and a first upper mold engaged onto said lower mold, to form a mold cavity therein and to form said prototype of the electric part in said mold cavity defined between said lower mold and said first upper mold of said mold device.

3. The method as claimed in claim 2, wherein said mold device includes a second upper mold engaged onto said lower mold after said first upper mold has been removed from said lower mold, to form a second mold cavity between said prototype and said second upper mold, said mixed material is injected into said second mold cavity and engaged onto said prototype of the electric part.
